(19) United States
(12) Patent Application Publication
(10) Pub. No.: US 2004/0178549 A1
(43) Pub. Date: Sep. 16, 2004

(54) FLEXIBLE ELEMENT

(75) Inventors: Kjell-Owe HJERTH, Braas (SE); Hakan STIGSSON, Vislanda (SE)

Correspondence Address: TRACY W. DRUCE, ESQ., 1496 EVANS FARM DR, MCLEAN, VA, 22101, US

(73) Assignee: VOLVO ARTICULATED HAULERS AB, Vaxjo (SE)

(21) Appl. No.: 10/708,590

(22) Filed: Mar. 12, 2004

Related U.S. Application Data
(63) Continuation of application No. PCT/SE02/01555, filed on Aug. 30, 2002.

(30) Foreign Application Priority Data
Sep. 14, 2001 (SE) 0103062-6

(51) Int. Cl. B62D 61/12

(52) U.S. Cl. 267/121

(57) ABSTRACT

Method and arrangement for providing a spring element configured to transmit compression forces and tensile forces between a vehicle frame and a wheel axle that are movably arranged with respect to one another. The spring element includes a rubber body and a mechanical connection member that extends through the rubber body. The mechanical connection member is arranged to limit the distancing movement between the vehicle frame and the wheel axle and has a coupling device for coupling the connection member to at least one of the vehicle frame and the wheel axle. The coupling device also has a first stub with a threaded portion protruding from the spring element and the first stub includes fixing means for obtaining a rotationally fixed, form-fit on said at least one of the vehicle frame and the wheel axle.

### CROSS REFERENCE TO RELATED APPLICATIONS

The present application is a continuation patent application of International Application No. PCT/SE02/01555 filed 30 Aug. 2002 which was published in English pursuant to Article 21(2) of the Patent Cooperation Treaty, and which claims priority to Swedish Application No. 0103062-6 filed 14 Sep. 2001. Both applications are expressly incorporated herein by reference in their entireties.

### BACKGROUND OF INVENTION

1. Technical Field

The present invention relates to a spring element intended to transmit compression forces and tensile forces between a vehicle frame and a wheel axle arranged movably in relation to the vehicle frame, and especially between a wheel axle and the end of a bogie beam that is mounted pivotably to such a vehicle frame. The spring element comprises (includes, but is not limited to) a rubber body, and a mechanical connection member that extends through the rubber body and is arranged to limit the distancing movement between the vehicle frame and wheel axle.

2. Background

As background, U.S. Pat. No. 4,615,513 (corresponding to SE 436 480 B) which is expressly incorporated herein by reference for purposes of disclosure, describes a spring element intended to transmit compression forces and tensile forces between a vehicle frame and a wheel axle arranged movably in relation to the vehicle frame. The spring element comprises two substantially parallel end-plates with a solid cylindrical rubber body vulcanized between the end-plates, and a connection member permitting limited relative movement between the end-plates. The connection member comprises a U-shaped link element which projects from each end-plate into the rubber body and whose branch ends are firmly clamped with nuts on the outside of the respective end-plate, and also a ring-shaped link element arranged between the U-shaped link elements. The maximum expansion of the spring element is thus limited; i.e., the maximum distancing movement (movement away from each other) of the end-plates when the spring element is subjected to tensile force. When fitting the spring element on the vehicle, eight bolts are used, four for each end-plate, and the bolts extend through holes in the respective end-plate.

A disadvantage of the abovementioned design of the connection member is that the tensile force which the spring element is intended to transmit is transmitted from the bolts, via the end-plates, to the U-shaped link elements and the ring-shaped link element. In turn, this means that the end-plates have to be made relatively strong (thick) so as not to deform on account of the fact that the tensile forces give rise to bending momentum in the end-plates. Another disadvantage is that the securing nuts for the U-shaped link elements take up a relatively large amount of space, and which reduces the bearing surface area of the end-plate against the vehicle frame and/or the wheel axle. Finally, the eight bolts are relatively awkward to fit, especially when out in the field and effecting servicing and repairs because the space available under the vehicle is relatively confined and there are strict requirements that the bolts be tightened with the correct momentum.

### SUMMARY OF INVENTION

It is an object of the present invention to provide a spring element in which the tensile force which the connection member of the spring element is intended to be able to transmit is transmitted directly to at least one of the vehicle frame and/or wheel axle. It is a further object to make a spring element available that is of compact construction and is not complicated to fit during production and in the field in connection with servicing and repairs.

According to a preferred embodiment of the invention, the coupling device comprises a threaded portion intended to cooperate with a threaded element when the spring element is coupled to one of the vehicle frame or wheel axle. This permits easy and rapid fitting and dismantling, both during production and also in the field in connection with servicing and repairs.

According to a further embodiment, the axis of symmetry of the threaded portion coincides with the axis of symmetry of the rubber body. This ensures that the tensile force which the spring element is intended to transfer does not give rise to bending momentum when the spring element is coupled to the vehicle frame or the wheel axle.

According to a further embodiment, the threaded portion comprises a stub (first stub), with internal threads, protruding from the spring element, which stub is intended to cooperate with a bolt for coupling the connection member. Because only one stub protrudes from the spring element, the spring element is made relatively compact and thus easier to insert into and remove from the space between the vehicle frame and the wheel axle during fitting/dismantling.

According to a further embodiment, the stub is designed with a conical portion. This makes it easier to fit the spring element to the vehicle frame or the wheel axle.

According to a further embodiment, the stub is designed to be rotationally fixed to the vehicle frame or wheel axle because of a conformance fit (form-fit). This ensures that the spring element does not rotate when the threaded element, preferably a bolt, is screwed in the stub during fitting/dismantling. According to a further embodiment, the form-fit is obtained in that the stub is designed with a bevel which is intended to cooperate with a corresponding bevel arranged on the vehicle frame or the wheel axle.

According to an alternative embodiment of the present invention, the threaded portion comprises a stub (second stub), with external thread, protruding from the spring element. This stub is intended to cooperate with the threaded element, preferably a nut, when the connection member is coupled to the vehicle frame or the wheel axle. This permits fitting/dismantling on vehicles where the space on the other side of the vehicle frame or wheel axle in relation to the spring element is so limited that a bolt cannot be inserted, and instead there is only room for a nut.

### BRIEF DESCRIPTION OF DRAWINGS

The invention will be described below in connection with the preferred illustrative embodiments and the attached figures, where:

FIG. 1 shows a diagrammatic view of a first embodiment, partly in cross section, of a spring element configured according to the teachings of present invention;

FIG. 2 shows a diagrammatic elevational (side) view, partly in cross section, of the spring element coupled to a bogie beam of a vehicle;

FIG. 3 shows a diagrammatic perspective view of the bevel on the stub, and of the corresponding bevel in the bogie beam for obtaining the rotationally fixed form-fit; and

FIG. 4 shows a diagrammatic view of an alternative embodiment, partly in cross section, of a spring element configured according to the teachings of the present invention.

### DETAILED DESCRIPTION

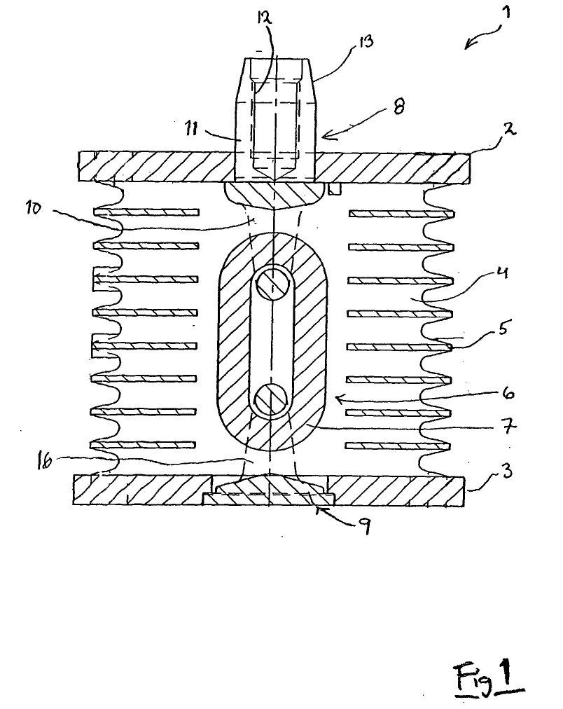

FIG. 1 shows a diagrammatic view of a first embodiment of a spring element 1 configured according to the present invention. The spring element 1 comprises a first end-plate 2 and a second end-plate 3 which are substantially parallel to one another when the spring element 1 is un-loaded. Vulcanized between the end-plates 2, 3 is a solid cylindrical rubber body 4 that is strengthened by means of a number of parallel and separate flat metal rings 5 to counteract outward bulging of the rubber body 4 under compression.

The end-plates 2, 3 are also held together by a mechanical connection member 6 which comprises a ring-shaped chain link 7 which joins a first coupling device 8, projecting from the central portion of the respective end-plate 2, 3 into the rubber body 4, and a second coupling device 9. The coupling devices 8, 9 preferably comprise fixing means for cooperation with the respective plate 2, 3, and which may be variously embodied and configured.

The first coupling device 8 has, on the one hand, a U-shaped link element 10 which extends into the rubber body 4 and is connected to the ring-shaped chain link 7 and, on the other hand, a stub 11, with an internal threaded portion 12, protruding through the first end-plate 2 from the spring element 1. By virtue of the fact that the axis of symmetry of the stub 11 substantially coincides with an axis of symmetry of the rubber body 4, which in turn substantially coincides with and is parallel to the force vector representing the tensile force which the spring element 1 is intended to transmit, it is ensured that bending momentum and shearing stresses are not generated in the first end-plate 2 of the spring element 1.

The fact that the stub 11 is designed with a conical portion 13 makes it easier to fit the spring element to the vehicle frame 14 or wheel axle 15.

The second coupling device 9 has a U-shaped link element 16 which is firmly connected to the second end-plate 3 and which extends into the rubber body 4 and is connected to the ring-shaped chain link 7.

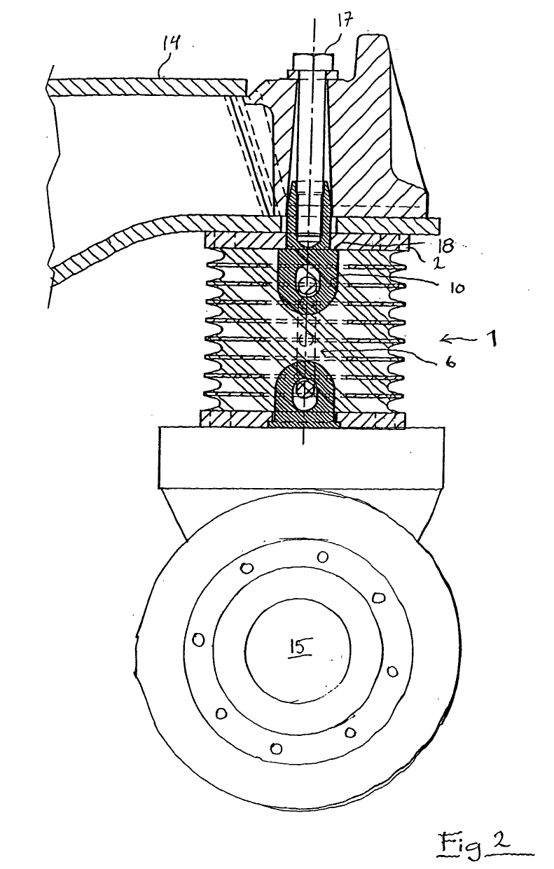

FIG. 2 shows a diagrammatic side view, partly in cross section, of the spring element 1 coupled to a bogie beam mounted pivotably in a vehicle frame 14 of a vehicle (not shown). For the sake of simplicity, only the coupling of the connection member 6 to a bogie beam is described. The threaded portion 12 of the stub 11 cooperates with a threaded element 17, exemplarily in the form of a bolt, which extends through the bogie beam. The fact that the U-shaped link element 10 of the stub 11 is provided with a flange 18 ensures that the first end-plate 2 bears against the bogie beam even when the spring element 1 transmits a tensile force.

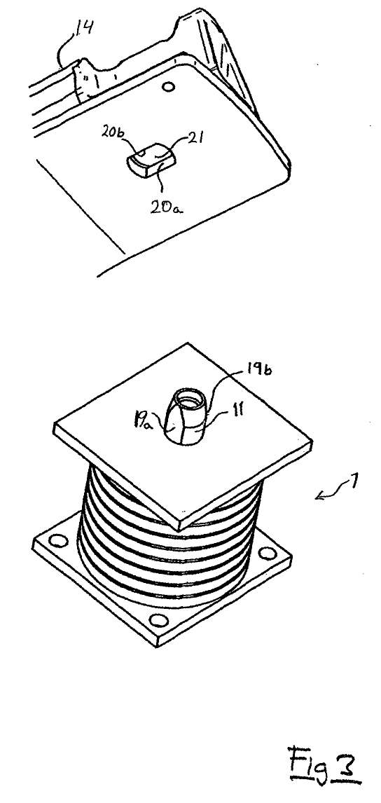

FIG. 3 shows a perspective view of the spring element 1 (below) and the bogie beam (above). By virtue of the fact that the stub 11 is designed with bevels 19a, 19b which are intended to cooperate with corresponding bevels 20a, 20b arranged in the through-passage 21 on the bogie beam for the stub 11, a form-fit is obtained that assures that the stub 11 is not permitted to rotate when the threaded element 17 is screwed in the stub 11 during fitting/dismantling.

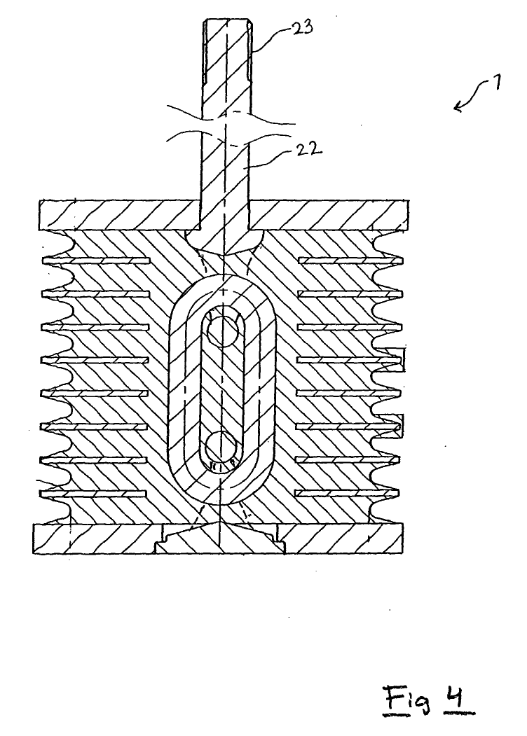

FIG. 4 shows an alternative embodiment of the spring element 1 that is also configured according to the teachings of the present invention. The structure of the spring element is the same as that of the above-described first embodiment, but with the difference that instead of the described stub 11 with an internally threaded portion 12, the coupling device 8 comprises a stub 22 protruding from the spring element 1 and having an externally threaded portion 23 intended to cooperate with a threaded element (not shown), preferably a nut, when the connection member 6 is coupled to the vehicle frame 14 or the wheel axle 15.

The invention must not be considered as being limited to the illustrative embodiments described above, and instead a number of further variants and modifications are conceivable within the scope of the patent claims. For example, instead of what is described above, the rubber body can accommodate the connection member in a central hole in the rubber body. Moreover, the rotationally fixed form-fit can be obtained with another cross section, for example square.

1. A spring element configured to transmit compression forces and tensile forces between a vehicle frame and a wheel axle that are movably arranged with respect to one another, said spring element comprises:
a rubber body;
a mechanical connection member that extends through the rubber body and is arranged to limit the distancing movement between the vehicle frame and the wheel axle, said connection member comprises a coupling device for coupling the connection member to at least one of the vehicle frame and the wheel axle; and
the coupling device further comprises a first stub with a threaded portion protruding from the spring element, the first stub including fixing means for obtaining a rotationally fixed, form-fit on said at least one of the vehicle frame and the wheel axle.

2. The spring element as recited in claim 1, wherein said transmittal of forces is effected between the wheel axle and an end of a bogie beam pivotably mounted to the vehicle frame.

3. The spring element as recited in claim 1, wherein said fixing means further comprises a bevel configured to cooperate with a corresponding bevel (20) arranged on said at least one of the vehicle frame and the wheel axle thereby enabling said form-fit.

4. The spring element as recited in claim 1, wherein an axis of symmetry of said threaded portion substantially coincides with an axis of symmetry of said rubber body.

5. The spring element as recited in claim 4, wherein said first stub comprises a conical portion.

6. The spring element as recited in claim 4, wherein said threaded portion further comprises a second stub with external threads and which protrudes from the spring element.

7. The spring element as recited in claim 1, wherein said threaded portions of the respective first and second stubs are configured to cooperate with a threaded element when coupled to a respective vehicle frame or wheel axle.
